(19) United States
(12) Patent Application Publication
(10) Pub. No.: US 2017/0272108 A1
(43) Pub. Date: Sep. 21, 2017

(54) MODEM ADAPTIVE ANTENNA TUNING (MAAT)

(71) Applicant: QUALCOMM Incorporated, San Diego, CA (US)

(72) Inventors: Daniel Fred FILIPOVIC, Solana Beach, CA (US); Adrianus VAN BEZOOIJEN, Molenhoek (NL); David Loweth WINSLOW, San Diego, CA (US); Jorge FABREGA SANCHEZ, San Diego, CA (US)

(21) Appl. No.: 15/460,508

(22) Filed: Mar. 16, 2017

Related U.S. Application Data
(60) Provisional application No. 62/367,213, filed on Jul. 27, 2016.
(60) Provisional application No. 62/311,353, filed on Mar. 21, 2016.

(51) Int. Cl. H04B 1/04; H04B 7/06

(52) U.S. Cl. CPC H04B 1/0458; H04B 7/0619

(57) ABSTRACT

Certain aspects of the present disclosure provide methods and apparatus for adaptive antenna tuning. One example method for wireless communications generally includes determining a first channel characteristic associated with a first component carrier and an antenna in an apparatus; determining a second channel characteristic associated with a second component carrier and the antenna; and controlling a tuner coupled to the antenna based on at least one of the first channel characteristic or the second channel characteristic. For certain aspects, the tuner is controlled according to predetermined characteristics of the tuner, where the predetermined characteristics of the tuner are independent from predetermined characteristics of the antenna.

### CLAIM OF PRIORITY UNDER 35 U.S.C. §119

The present application claims the benefit of U.S. Provisional Application Ser. No. 62/311,353, entitled “MODEM ADAPTIVE ANTENNA TUNING (MAAT)” and filed Mar. 21, 2016, and the benefit of U.S. Provisional Application Ser. No. 62/367,213, sharing the same title and filed Jul. 27, 2016, both of which are assigned to the assignee of the present application and are expressly incorporated by reference herein in their entireties.

### TECHNICAL FIELD

Certain aspects of the present disclosure generally relate to wireless communications and, more particularly, to adaptive antenna tuning.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. For example, one network may be a 3G (the third generation of mobile phone standards and technology) system, which may provide network service via any one of various 3G radio access technologies (RATs) including EVDO (Evolution-Data Optimized), 1×RTT (1 times Radio Transmission Technology, or simply 1×), W-CDMA (Wideband Code Division Multiple Access), UMTS-TDD (Universal Mobile Telecommunications System—Time Division Duplexing), HSPA (High Speed Packet Access), GPRS (General Packet Radio Service), or EDGE (Enhanced Data rates for Global Evolution). The 3G network is a wide area cellular telephone network that evolved to incorporate high-speed internet access and video telephony, in addition to voice calls. Furthermore, a 3G network may be more established and provide larger coverage areas than other network systems. Such multiple access networks may also include code division multiple access (CDMA) systems, time division multiple access (TDMA) systems, frequency division multiple access (FDMA) systems, orthogonal frequency division multiple access (OFDMA) systems, single-carrier FDMA (SC-FDMA) networks, 3^{rd} Generation Partnership Project (3GPP) Long Term Evolution (LTE) networks, and Long Term Evolution Advanced (LTE-A) networks.

A wireless communication network may include a number of base stations that can support communication for a number of mobile stations. A mobile station (MS) may communicate with a base station (BS) via a downlink and an uplink. The downlink (or forward link) refers to the communication link from the base station to the mobile station, and the uplink (or reverse link) refers to the communication link from the mobile station to the base station. A base station may transmit data and control information on the downlink to a mobile station and/or may receive data and control information on the uplink from the mobile station. The base station and/or the mobile station may include one/or more antennas for transmitting and/or receiving wireless signals. At least one of these antennas may be tunable.

### SUMMARY

Certain aspects of the present disclosure generally relate to adaptive antenna tuning. Such adaptive antenna tuning may be implemented in a carrier aggregation (CA) transceiver.

Certain aspects of the present disclosure provide a method for wireless communications. The method generally includes determining a first channel characteristic associated with a first component carrier and a first antenna in an apparatus; determining a second channel characteristic associated with a second component carrier and the first antenna; and controlling a first tuner coupled to the first antenna based on one or more predetermined characteristics of the first tuner and on at least one of the first channel characteristic or the second channel characteristic, the predetermined characteristics of the first tuner being independent from predetermined characteristics of the first antenna.

Certain aspects of the present disclosure provide an apparatus for wireless communications. The apparatus generally includes a first antenna, a first tuner coupled to the first antenna, and a processor coupled to the first tuner. The processor is configured to determine a first channel characteristic associated with a first component carrier and the first antenna, to determine a second channel characteristic associated with a second component carrier and the first antenna, and to control the first tuner based on one or more predetermined characteristics of the first tuner and at least one of the first channel characteristic or the second channel characteristic, the predetermined characteristics of the first tuner being independent from different effective configurations of the first antenna.

Certain aspects of the present disclosure provide an apparatus for wireless communications. The apparatus generally includes means for transceiving a signal; means for determining a first channel characteristic associated with a first component carrier and the means for transceiving; means for determining a second channel characteristic associated with a second component carrier and the means for transceiving; and means for adjusting an impedance for the means for transceiving, based on one or more predetermined characteristics of the means for adjusting and on at least one of the first channel characteristic or the second channel characteristic, the predetermined characteristics of the means for adjusting being independent from predetermined characteristics of the means for transceiving.

Certain aspects of the present disclosure provide a method for wireless communications. The method generally includes determining a first channel characteristic associated with a first component carrier and a first antenna in an apparatus; determining a second channel characteristic associated with a second component carrier and the first antenna; determining a user interaction condition of the apparatus; and controlling a first tuner coupled to the first antenna based on the user interaction condition of the apparatus and on at least one of the first channel characteristic or the second channel characteristic.

Certain aspects of the present disclosure provide an apparatus for wireless communications. The apparatus generally includes an antenna, an antenna tuner coupled to the antenna, and a processor coupled to the antenna tuner. The processor is configured to determine a first channel characteristic associated with a first component carrier and the antenna; to determine a second channel characteristic associated with a second component carrier and the antenna; to determine a user interaction condition of the apparatus; and to control the antenna tuner based on the user interaction condition of the apparatus and on at least one of the first channel characteristic or the second channel characteristic.

Certain aspects of the present disclosure provide an apparatus for wireless communications. The apparatus generally includes means for transceiving a signal; means for determining a first channel characteristic associated with a first component carrier and the means for transceiving; means for determining a second channel characteristic associated with a second component carrier and the means for transceiving; means for determining a user interaction condition of the apparatus; and means for adjusting an impedance for the means for transceiving, based on the user interaction condition of the apparatus and on at least one of the first channel characteristic or the second channel characteristic.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram of an example wireless communications network, in accordance with certain aspects of the present disclosure.

FIG. 2 is a block diagram of an example access point (AP) and example user terminals, in accordance with certain aspects of the present disclosure.

FIG. 3 is a block diagram of an example transceiver front-end, in accordance with certain aspects of the present disclosure.

FIG. 4A is a block diagram of an example transceiver front-end with antenna diversity and a feedback receive (FBRx) path, in accordance with certain aspects of the present disclosure.

FIG. 4B illustrates the example transceiver front-end of FIG. 4A with the tuners electrically disconnected from corresponding antennas, in accordance with certain aspects of the present disclosure.

FIG. 5 is a flow diagram of example operations for adaptive antenna tuning, in accordance with certain aspects of the present disclosure.

FIG. 6 is an example conceptual diagram of various inputs for adaptive antenna tuning of multiple antennas in a downlink carrier aggregation (CA) scenario with two component carriers (CCs), in accordance with certain aspects of the present disclosure.

FIG. 7 is an example conceptual diagram of various inputs for adaptive antenna tuning of multiple antennas in a downlink CA scenario with three CCs, in accordance with certain aspects of the present disclosure.

FIG. 8 illustrates selecting an example tuner code based on one or more rule conditions, in accordance with certain aspects of the present disclosure.

FIG. 9 is an example table of parameters for each of a plurality of frequencies, wherein the parameters are organized according to different antennas and various user interface conditions per antenna, in accordance with certain aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

The techniques described herein may be used in combination with various wireless technologies such as Code Division Multiple Access (CDMA), Orthogonal Frequency Division Multiplexing (OFDM), Time Division Multiple Access (TDMA), Spatial Division Multiple Access (SDMA), Single Carrier Frequency Division Multiple Access (SC-FDMA), Time Division Synchronous Code Division Multiple Access (TD-SCDMA), and so on. Multiple user terminals can concurrently transmit/receive data via different (1) orthogonal code channels for CDMA, (2) time slots for TDMA, or (3) sub-bands for OFDM. A CDMA system may implement IS-2000, IS-95, IS-856, Wideband-CDMA (W-CDMA), or some other standards. An OFDM system may implement Institute of Electrical and Electronics Engineers (IEEE) 802.11, IEEE 802.16, Long Term Evolution (LTE) (e.g., in TDD and/or FDD modes), or some other standards. A TDMA system may implement Global System for Mobile Communications (GSM) or some other standards. These various standards are known in the art.

### An Example Wireless System

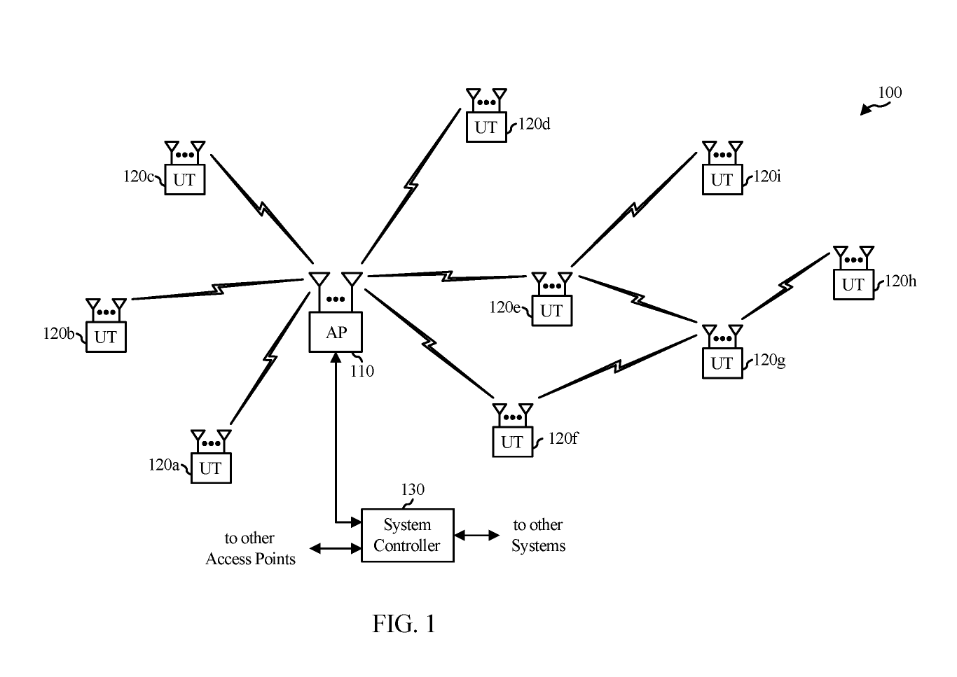

FIG. 1 illustrates a wireless communications system 100 with access points 110 and user terminals 120, in which aspects of the present disclosure may be practiced. For simplicity, only one access point 110 is shown in FIG. 1. An access point (AP) is generally a fixed station that communicates with the user terminals and may also be referred to as a base station (BS), an evolved Node B (eNB), or some other terminology. A user terminal (UT) may be fixed or mobile and may also be referred to as a mobile station (MS), an access terminal, user equipment (UE), a station (STA), a client, a wireless device, or some other terminology. A user terminal may be a wireless device, such as a cellular phone, a personal digital assistant (PDA), a handheld device, a wireless modem, a laptop computer, a tablet, a personal computer, etc.

Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

System 100 employs multiple transmit and multiple receive antennas for data transmission on the downlink and uplink. Access point 110 may be equipped with a number Nₐₚ of antennas to achieve transmit diversity for downlink transmissions and/or receive diversity for uplink transmissions. A set Nᵤ of selected user terminals 120 may receive downlink transmissions and transmit uplink transmissions. Each selected user terminal transmits user-specific data to and/or receives user-specific data from the access point. In general, each selected user terminal may be equipped with one or multiple antennas (i.e., Nᵤₜ≧1). The Nᵤ selected user terminals can have the same or different number of antennas.

Wireless system 100 may be a time division duplex (TDD) system or a frequency division duplex (FDD) system. For a TDD system, the downlink and uplink share the same frequency band. For an FDD system, the downlink and uplink use different frequency bands. System 100 may also utilize a single carrier or multiple carriers for transmission. Each user terminal 120 may be equipped with a single antenna (e.g., in order to keep costs down) or multiple antennas (e.g., where the additional cost can be supported).

The access point 110 and/or user terminal 120 may include a variable tuner coupled to an antenna and be capable of performing modem adaptive antenna tuning by controlling a variable impedance of the tuner.

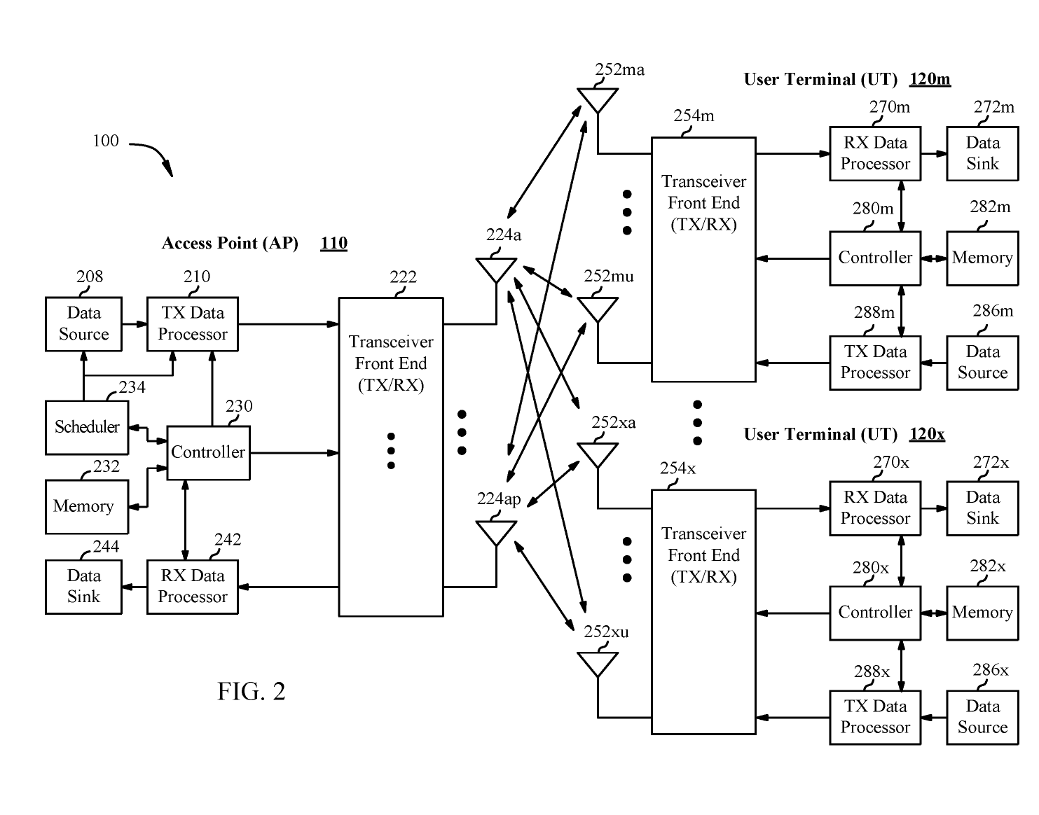

FIG. 2 shows a block diagram of access point 110 and two user terminals 120m and 120x in wireless system 100. Access point 110 is equipped with Nₐₚ antennas 224a through 224ap. User terminal 120m is equipped with N_{ut,m} antennas 252ma through 252mu, and user terminal 120x is equipped with N_{ut, x} antennas 252xa through 252xu. Access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a frequency channel, and a “receiving entity” is an independently operated apparatus or device capable of receiving data via a frequency channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. Beam-steering or some other spatial processing technique may be used at the access point and user terminal.

On the uplink, at each user terminal 120 selected for uplink transmission, a TX data processor 288 receives traffic data from a data source 286 and control data from a controller 280. TX data processor 288 processes (e.g., encodes, interleaves, and modulates) the traffic data {dᵤₚ} for the user terminal based on the coding and modulation schemes associated with the rate selected for the user terminal and provides a data symbol stream {sᵤₚ}for one of the N_{ut,m} antennas. A transceiver front-end (TX/RX) 254 (also known as a radio frequency front-end (RFFE)) receives and processes (e.g., converts to analog, amplifies, filters, and frequency upconverts) a respective symbol stream to generate an uplink signal. The transceiver front-end 254 may also route the uplink signal to one of the N_{ut,m} antennas for transmit diversity via an RF switch, for example. The controller 280 may control the routing within the transceiver front-end 254. Memory 282 may store data and program codes for the user terminal 120 and may interface with the controller 280.

A number Nᵤₚ of user terminals 120 may be scheduled for simultaneous transmission on the uplink. Each of these user terminals transmits its set of processed symbol streams on the uplink to the access point.

At access point 110, Nₐₚ antennas 224a through 224ap receive the uplink signals from all Nᵤₚ user terminals transmitting on the uplink. For receive diversity, a transceiver front-end 222 may select signals received from one of the antennas 224 for processing. The signals received from multiple antennas 224 may be combined for enhanced receive diversity. The access point's transceiver front-end 222 also performs processing complementary to that performed by the user terminal's transceiver front-end 254 and provides a recovered uplink data symbol stream. The recovered uplink data symbol stream is an estimate of a data symbol stream {sᵤₚ} transmitted by a user terminal. An RX data processor 242 processes (e.g., demodulates, deinterleaves, and decodes) the recovered uplink data symbol stream in accordance with the rate used for that stream to obtain decoded data. The decoded data for each user terminal may be provided to a data sink 244 for storage and/or a controller 230 for further processing.

The transceiver front-end (TX/RX) 222 of access point 110 and/or transceiver front-end 254 of user terminal 120 may include a variable tuner coupled to an antenna and be capable of performing modem adaptive antenna tuning by controlling a variable impedance of the tuner.

On the downlink, at access point 110, a TX data processor 210 receives traffic data from a data source 208 for N_{dn} user terminals scheduled for downlink transmission, control data from a controller 230 and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 may provide a downlink data symbol streams for one of more of the N_{dn} user terminals to be transmitted from one of the Nₐₚ antennas. The transceiver front-end 222 receives and processes (e.g., converts to analog, amplifies, filters, and frequency upconverts) the symbol stream to generate a downlink signal. The transceiver front-end 222 may also route the downlink signal to one or more of the Nₐₚ antennas 224 for transmit diversity via an RF switch, for example. The controller 230 may control the routing within the transceiver front-end 222. Memory 232 may store data and program codes for the access point 110 and may interface with the controller 230.

At each user terminal 120, N_{ut,m} antennas 252 receive the downlink signals from access point 110. For receive diversity at the user terminal 120, the transceiver front-end 254 may select signals received from one of the antennas 252 for processing. The signals received from multiple antennas 252 may be combined for enhanced receive diversity. The user terminal's transceiver front-end 254 also performs processing complementary to that performed by the access point's transceiver front-end 222 and provides a recovered downlink data symbol stream. An RX data processor 270 processes (e.g., demodulates, deinterleaves, and decodes) the recovered downlink data symbol stream to obtain decoded data for the user terminal.

Those skilled in the art will recognize the techniques described herein may be generally applied in systems utilizing any type of multiple access schemes, such as TDMA, SDMA, Orthogonal Frequency Division Multiple Access (OFDMA), CDMA, SC-FDMA, TD-SCDMA, and combinations thereof.

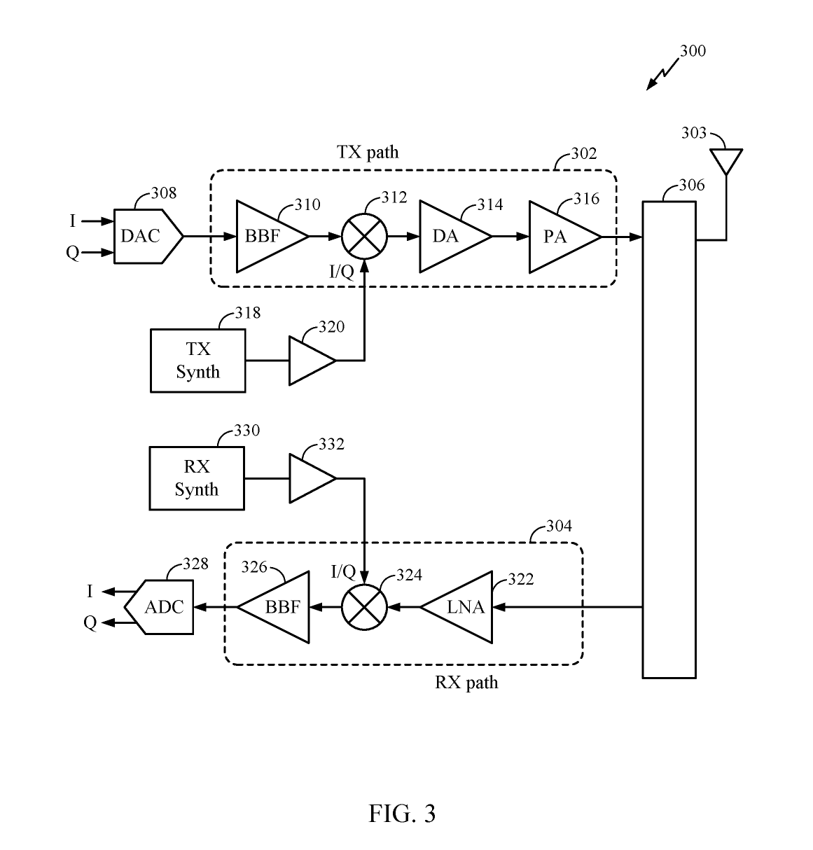

FIG. 3 is a block diagram of an example transceiver front-end 300, such as transceiver front-ends 222, 254 in FIG. 2, in which aspects of the present disclosure may be practiced. The transceiver front-end 300 includes a transmit (TX) path 302 (also known as a transmit chain) for transmitting signals via one or more antennas and a receive (RX) path 304 (also known as a receive chain) for receiving signals via the antennas. When the TX path 302 and the RX path 304 share an antenna 303, the paths may be connected with the antenna via an interface 306, which may include any of various suitable RF devices, such as a duplexer, a switch, a diplexer, and the like.

Receiving in-phase (I) or quadrature (Q) baseband analog signals from a digital-to-analog converter (DAC) 308, the TX path 302 may include a baseband filter (BBF) 310, a mixer 312, a driver amplifier (DA) 314, and a power amplifier (PA) 316. The BBF 310, the mixer 312, and the DA 314 may be included in a radio frequency integrated circuit (RFIC), while the PA 316 may be external to the RFIC. The BBF 310 filters the baseband signals received from the DAC 308, and the mixer 312 mixes the filtered baseband signals with a transmit local oscillator (LO) signal to convert the baseband signal of interest to a different frequency (e.g., upconvert from baseband to RF). This frequency conversion process produces the sum and difference frequencies of the LO frequency and the frequency of the signal of interest. The sum and difference frequencies are referred to as the beat frequencies. The beat frequencies are typically in the RF range, such that the signals output by the mixer 312 are typically RF signals, which may be amplified by the DA 314 and/or by the PA 316 before transmission by the antenna 303.

The RX path 304 includes a low noise amplifier (LNA) 322, a mixer 324, and a baseband filter (BBF) 326. The LNA 322, the mixer 324, and the BBF 326 may be included in a radio frequency integrated circuit (RFIC), which may or may not be the same RFIC that includes the TX path components. RF signals received via the antenna 303 may be amplified by the LNA 322, and the mixer 324 mixes the amplified RF signals with a receive local oscillator (LO) signal to convert the RF signal of interest to a different baseband frequency (i.e., downconvert). The baseband signals output by the mixer 324 may be filtered by the BBF 326 before being converted by an analog-to-digital converter (ADC) 328 to digital I or Q signals for digital signal processing.

While it is desirable for the output of an LO to remain stable in frequency, tuning to different frequencies indicates using a variable-frequency oscillator, which involves compromises between stability and tunability. Contemporary systems may employ frequency synthesizers with a voltage-controlled oscillator (VCO) to generate a stable, tunable LO with a particular tuning range. Thus, the transmit LO frequency may be produced by a TX frequency synthesizer 318, which may be buffered or amplified by amplifier 320 before being mixed with the baseband signals in the mixer 312. Similarly, the receive LO frequency may be produced by an RX frequency synthesizer 330, which may be buffered or amplified by amplifier 332 before being mixed with the RF signals in the mixer 324.

In some aspects of the present disclosure, the interface 306 may include a variable tuner coupled to the antenna, and the transceiver front-end 300 may be capable of performing modem adaptive antenna tuning by dynamically adjusting a variable impedance of the tuner.

### Example Modem Adaptive Antenna Tuning

Carrier aggregation is used in some radio access technologies (RATs), such as LTE-A, in an effort to increase the bandwidth, and thereby increase bitrates. In carrier aggregation, multiple frequency resources (i.e., carriers) are allocated for sending data. Each aggregated carrier is referred to as a component carrier (CC). In LTE Rel-10, for example, up to five component carriers can be aggregated, leading to a maximum aggregated bandwidth of 100 MHz. The allocation of resources may be contiguous or non-contiguous. Non-contiguous allocation may be either intra-band (i.e., the component carriers belong to the same operating frequency band, but have one or more gaps in between) or inter-band, in which case the component carriers belong to different operating frequency bands. To implement CA in radio frequency front-ends (RFFEs), various CA transceivers have been developed.

In wireless communications, diversity may be used to increase the reliability of transmissions by using two or more channels with different characteristics. Because individual channels experience different levels of fading and interference, multiple versions of the same signal may be received via different propagation paths in reception diversity in an effort to combat fading and interference. For example, a 2-way diversity (a.k.a. ordinary diversity, as opposed to multi-way diversity) receiver may use two antennas associated with two different receive paths, one referred to as the “primary path” and the other referred to as the “diversity path.”

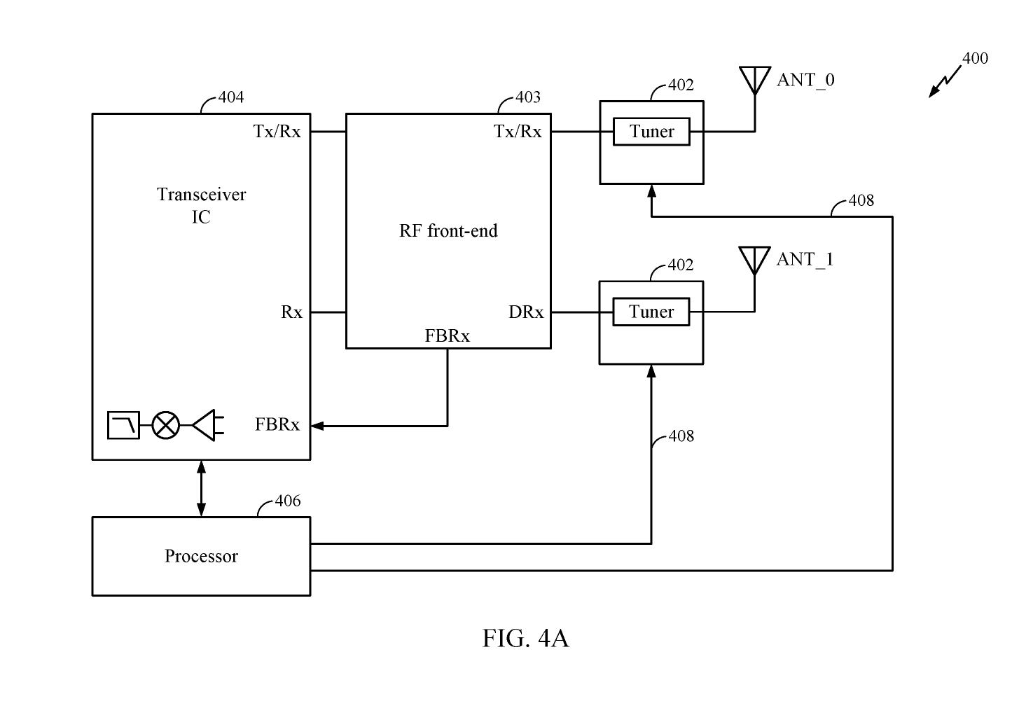

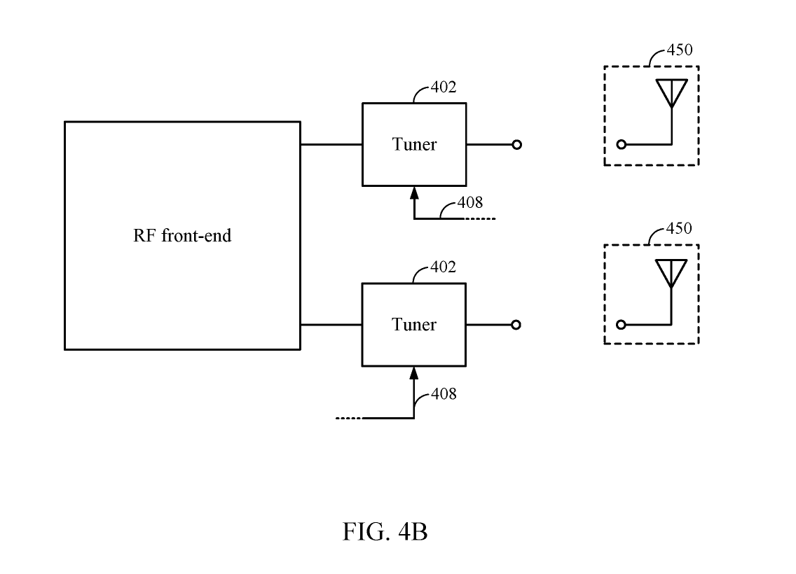

FIG. 4A is a block diagram of an example transceiver front-end 400 with antenna diversity and a feedback receive (FBRx) path, in accordance with certain aspects of the present disclosure. The transceiver front-end 400 may include multiple antennas (e.g., two antennas labeled “ANT_0” and “ANT_1”) coupled to an RF front-end (RFFE) 403 via one or more variable tuners 402 (e.g., programmable tuners). The RFFE 403 may include any of various suitable RF devices, such as a duplexer, a switch, a diplexer, and the like. Although only two antennas are illustrated in FIG. 4A, certain aspects of the present disclosure may include more than two antennas. The transceiver front-end 400 may be capable of performing modem adaptive antenna tuning of the multiple antennas by dynamically adjusting the variable impedance of the tuners 402 on the fly as conditions (e.g., modem metrics and user interface conditions) change. For certain aspects, a processor 406 may receive a plurality of inputs (representative of the changing conditions) and output one or more control signals 408 for controlling the tuners 402. The processor 406 may be a separate component as illustrated in FIG. 4A or may be part of a transceiver integrated circuit (IC) 404 connected with the RFFE 403.

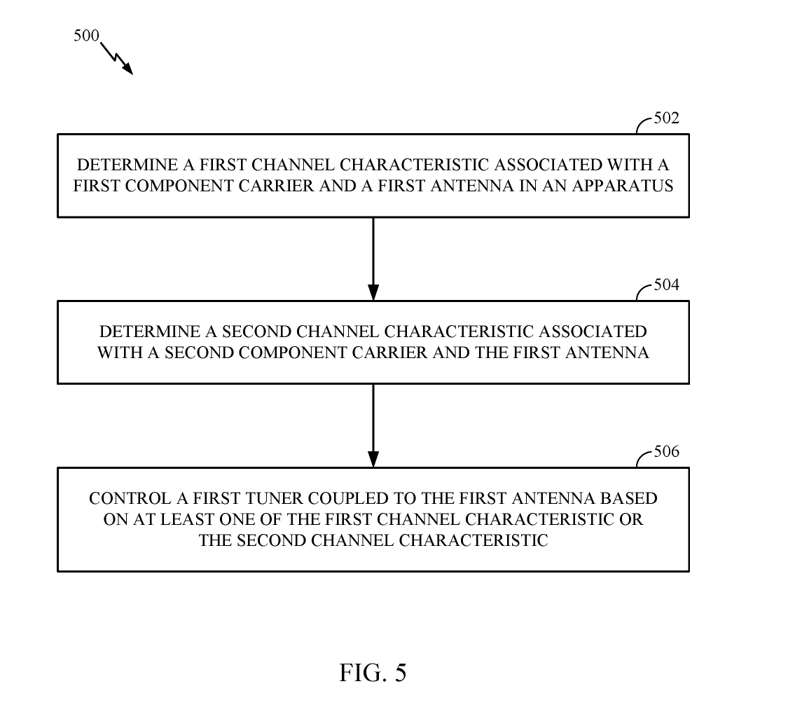

FIG. 5 is a flow diagram of example operations 500 for adaptive antenna tuning. The operations 500 may be performed, for example, by an apparatus (e.g., a user terminal 120) with a transceiver, such as the transceiver front-end 300 or transceiver front-end 400 described above.

The operations 500 may begin, at block 502, with the apparatus determining a first channel characteristic associated with a first component carrier and a first antenna in the apparatus. The apparatus may determine a second channel characteristic associated with a second component carrier and the first antenna at block 504. At block 506, the apparatus may control a first tuner coupled to the first antenna based on at least one of the first channel characteristic or the second channel characteristic.

According to certain aspects, the first and/or second channel characteristics may be modem metrics, as described below.

According to certain aspects, the apparatus may control the first tuner at block 506 by controlling the first tuner according to one or more predetermined characteristics of the first tuner (e.g., power and/or impedance of the first tuner at different frequencies). The predetermined characteristics of the first tuner may be independent from predetermined characteristic(s) of the first antenna (e.g., different effective configurations of the first antenna).

According to certain aspects, the operations 500 may further involve the apparatus determining a third channel characteristic associated with a third component carrier and a second antenna in the apparatus and controlling a second tuner coupled to the second antenna based on the third channel characteristic. For certain aspects, the operations 500 may further include the apparatus determining that the third channel characteristic meets a rule condition and selecting a tuner code from a predetermined set of tuner codes based on meeting the rule condition. In this case, controlling the second tuner may entail applying the selected tuner code to the second tuner to control a variable impedance of the second tuner. For other aspects, the operations 500 may further involve the apparatus determining that the third channel characteristic fails to meet a first rule condition; determining a fourth channel characteristic associated with a fourth component carrier and the second antenna; determining that the fourth channel characteristic meets a second rule condition; and selecting a tuner code from a predetermined set of tuner codes based on meeting the second rule condition. In this case, controlling the second tuner may entail applying the selected tuner code to the second tuner to control a variable impedance of the second tuner. For certain aspects, the fourth component carrier is a primary component carrier (PCC), and the third component carrier is a secondary component carrier (SCC). For other aspects, the third component carrier is an SCC, and the fourth component carrier is another SCC. For certain aspects, the operations 500 may further include the apparatus determining a user interaction condition of the apparatus. In this case, controlling the first tuner at block 506 may involve controlling the first tuner based on the user interaction condition of the apparatus and on the at least one of the first channel characteristic or the second channel characteristic; and controlling the second tuner may entail controlling the second tuner based on the third channel characteristic and the user interaction condition of the apparatus.

According to certain aspects, the first antenna is disposed adjacent a first surface of the apparatus, and the second antenna is disposed adjacent a second surface of the apparatus, different from the first surface. For example, the first surface may be a lower surface of the apparatus (e.g., the bottom), and the second surface may be an upper surface of the apparatus (e.g., the top), opposite from the lower surface. For certain aspects, the apparatus includes a transmit path coupled to the first antenna and the first tuner and a receive path coupled to the second antenna and the second tuner. In this case, the at least one of the first component carrier or the second component carrier may be a transmit component carrier, and controlling the first tuner at block 502 may involve controlling the first tuner for the transmit path. Furthermore, the third component carrier may be a receive component carrier, and controlling the second tuner may entail controlling the second tuner for the receive path. In this manner, two antenna tuners may be adjusted for what is referred to as “joint antenna optimization” (e.g., adjusting TX for a bottom antenna and adjusting RX for a top antenna). In joint antenna optimization, by understanding the operation of each receive path and transmit path, the tuners can be adapted jointly in an effort to provide the best performance across all bands for receivers and transmitters.

Joint antenna optimization may also involve adjusting more than two antenna tuners in cases, for example, where more than two antennas are operating concurrently. For example, the apparatus may include 3, 4, 5, 6, or more antennas, where all or a subset of the antennas may be configured for concurrent signal reception. All or a subset of the multiple antenna tuners associated with the operating antennas may be adjusted for joint antenna optimization.

According to certain aspects, the operations 500 may further involve the apparatus determining a user interaction condition of the apparatus. In this case, controlling the first tuner at block 506 may include controlling the first tuner based on the user interaction condition of the apparatus and on the at least one of the first channel characteristic or the second channel characteristic. For example, determining the user interaction condition of the apparatus may include at least one of sensing a proximity parameter for the apparatus (e.g., of an object external to the apparatus, such as a user's head and/or hand); sensing movement of the apparatus or lack thereof (i.e., that the apparatus is not moving); detecting whether a device is connected to the apparatus; or detecting an impedance characteristic of the first antenna. For certain aspects, determining the user interaction condition of the apparatus includes assuming a free space (FS) condition for the apparatus.

According to certain aspects, controlling the first tuner at block 506 involves adjusting the first tuner over time as the at least one of the first channel characteristic or the second channel characteristic changes.

According to certain aspects, controlling the first tuner at block 506 includes dynamically adjusting the first tuner during operation of the apparatus.

According to certain aspects, the apparatus may control the first tuner at block 506 by adjusting the first tuner such that the first antenna is detuned from a second antenna in the apparatus in an effort to avoid leakage between the first antenna and the second antenna (e.g., reduce the adjacent channel leakage ratio (ACLR) between first and second channels associated with the first and second antennas, respectively).

According to certain aspects, the operations 500 may further involve determining that the first channel characteristic meets a rule condition and selecting a tuner code from a predetermined set of tuner codes based on meeting the rule condition. In this case, controlling the first tuner at block 506 may entail applying the selected tuner code to the first tuner to control a variable impedance of the first tuner.

According to certain aspects, the operations 500 may further include determining that the first channel characteristic fails to meet a first rule condition; determining that the second channel characteristic meets a second rule condition; and selecting a tuner code from a predetermined set of tuner codes based on meeting the second rule condition. In this case, controlling the first tuner may entail applying the selected tuner code to the first tuner to control a variable impedance of the first tuner.

According to certain aspects, the first component carrier may be a transmit primary component carrier (PCC) (e.g., Tx_pcc), and the second component carrier may be a receive PCC (e.g. PRx_pcc). For other aspects, the first component carrier may be a transmit PCC, and the second component carrier may be a receive secondary component carrier (SCC) (e.g., PRx_scc).

According to certain aspects, the first channel characteristic includes a signal-to-noise ratio (SNR) of the first component carrier received by the apparatus (e.g., SNR0_Pcc or SNR0_Scc).

According to certain aspects, the first channel characteristic comprises a transmit signal level (Tx) of the first component carrier.

According to certain aspects, the first and second component carriers are allocated for carrier aggregation (CA).

According to certain aspects, the apparatus includes a receive path. In this case, first and second component carriers may be receive component carriers, and controlling the first tuner at block 506 may involve controlling the first tuner only for the receive path. For certain aspects, the first antenna has no transmit path associated therewith (e.g., the first antenna is not used for transmitting signals, only for receiving signals).

FIG. 4B illustrates the example transceiver front-end 400 of FIG. 4A with each of the tuners 402 electrically disconnected from the antenna 450 associated therewith, in accordance with certain aspects of the present disclosure. This electrical disconnection may be performed, for example, by physically breaking the RF front-end circuit path (e.g., by cutting a trace on a printed circuit board (PCB) between a particular tuner 402 and the corresponding antenna 450). Separating the tuner 402 from the corresponding antenna 450 may be done in an effort to characterize (e.g., measure and/or model) any of various suitable properties (e.g., power, impedance, etc. for different frequencies) of the tuner 402 (and more specifically, of the RF front-end circuit path with the tuner) without the effects of the antenna 450. This characterization may be performed in a laboratory by the manufacturer, for example, without an antenna present in the particular RF front-end circuit path under test, thereby generating predetermined characteristics of the tuner. In this manner, certain aspects of the present disclosure can characterize the tuner 402 for this RF front-end circuit path independent of the antenna during test mode, and in normal operation, the tuner 402 can be dynamically adjusted for any antennas or antenna configurations (e.g., due to different UI conditions). Measuring the tuner 402 independently of the effects of an antenna provides flexibility in dynamically adjusting the tuner for various antennas and/or antenna configurations, without a memory implicated to store a frequency response across a frequency range for each combination of tuner and antenna configuration.

For certain aspects, the antenna 450 (or various antennas and antenna configurations) may be characterized (e.g., measured and/or modeled) independently from the tuner 402. Such characterization of the antenna(s) and antenna configurations may be performed by the manufacturer. For example, various scattering parameters (S-parameters) of the antenna 450, such as S11 (the input port voltage reflection coefficient), may be measured at different frequencies and stored.

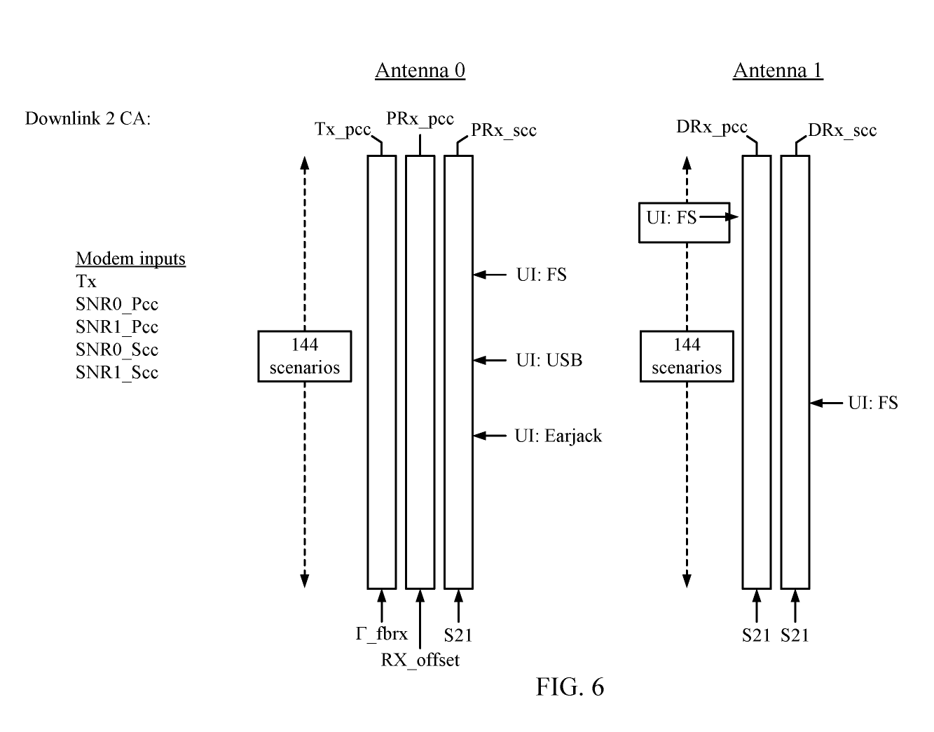

FIG. 6 is an example conceptual diagram of various inputs for adaptive antenna tuning of multiple antennas in a downlink CA scenario with two component carriers (CCs) (referred to as “Downlink 2 CA”), in accordance with certain aspects of the present disclosure. In this case, two antennas (Antenna 0 and Antenna 1) may be used. Antenna 0 may be used for transmitting the transmit primary component carrier (PCC) (e.g., Tx_pcc) and for receiving either the primary antenna receive PCC (e.g., PRx_pcc) or the primary antenna secondary component carrier (SCC) (e.g., PRx_scc). Antenna 1 may be used for receiving either the diversity antenna receive PCC (e.g., DRx_pcc) or the diversity antenna SCC (e.g., DRx_scc).

The columns in FIG. 6 represent a number of possible tuner code settings for controlling a variable impedance of a tuner (e.g., tuner 402) coupled to a particular antenna. For example, there may be 144 different tuner code settings for Antenna 0 (ANT_0) and/or Antenna 1 (ANT_1). These different tuner codes may allow each individual RF front-end circuit path to be tuned to cover different frequency bands, such as from 700 MHz to 2.5 GHz, and different antenna configurations, as described below.

The various inputs for adaptive antenna tuning may include modem inputs, such as the transmit signal level (e.g., of Tx_pcc), the signal-to-noise ratio (SNR) for the receive PCC on Antenna 0 (SNR0_Pcc), the SNR for the receive SCC on Antenna 0 (SNR0_Scc), the SNR for the receive PCC on Antenna 1 (SNR1_Pcc), and the SNR for the receive SCC on Antenna 1 (SNR1_Scc). Other inputs may include the reflection determined by the FBRx path (e.g., Γ_fbrx), the receive offset frequency (RX_offset) between the transmit and receive PCC frequencies, and one or more scattering parameters (S-parameters), such as S21 (the forward voltage gain, which may indicate antenna matching).

During normal operation for a particular RF front-end circuit path in certain aspects, the device may determine (e.g., calculate) power transferred through the tuner 402 for a set of tuner codes (e.g., a large set of usable tuner codes, which may include all tuner codes in certain aspects). This calculation may be based on the adaptive antenna tuning inputs and a model of the tuner 402. For certain aspects, the device may select the tuner code with the highest calculated power or use some additional and/or alternative criteria to select the tuner code and dynamically adjust the tuner 402.

Optionally, for certain aspects, inputs associated with a user interaction (UI) condition may also be considered in determining the tuner code. For example, one or more proximity sensors (e.g., infrared (IR) or capacitive proximity sensors) in the user terminal may detect whether a head and/or a hand is close to an antenna. An accelerometer or a gyroscope may sense whether the user terminal is moving. Other inputs may include detections of whether other devices are connected to the user terminal, such as whether a device is plugged into the headset/auxiliary jack or the Universal Serial Bus (USB) port. For example, a free space (FS) condition may be determined when an IR proximity sensor detects a user's head is not proximate to the user terminal, a capacitive proximity sensor detects a user's hand is not close to an antenna, the accelerometer or gyroscope detects no (random) movement of the user terminal, nothing is plugged into the user terminal (e.g., no headset or USB), and the difference between the detected antenna impedance (e.g., as detected by the FBRx path) and a FS reference impedance is less than a particular impedance threshold. These different UI conditions effectively lead to different antenna configurations, and certain aspects of the present disclosure may dynamically adjust the associated tuner (e.g., alter the tuner code) for these different antenna configurations. For certain aspects, interpolation between different UI conditions (e.g., in addition to frequencies and channel conditions) may be performed to dynamically adjust the tuner, in an effort to maintain tuning resolution over more UI conditions than are stored in the device.

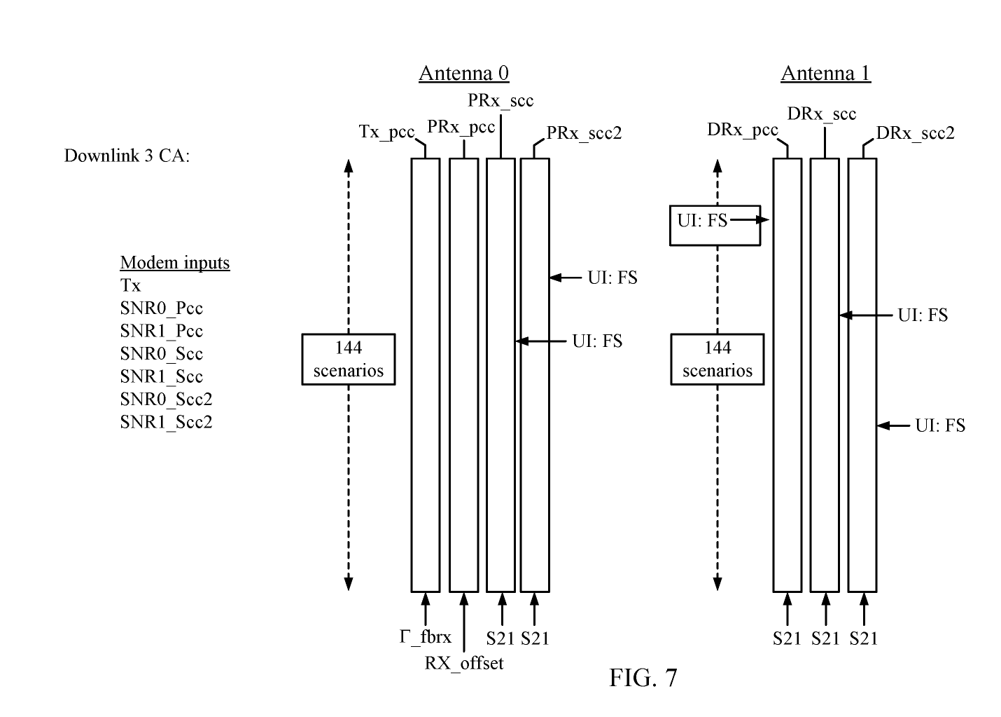

FIG. 7 is an example conceptual diagram of various inputs for adaptive antenna tuning of multiple antennas in a downlink CA scenario with three CCs (referred to as “Downlink 3 CA”), in accordance with certain aspects of the present disclosure. In this case, Antenna 0 may be used for transmitting the transmit PCC (e.g., Tx_pcc) and for receiving the primary antenna receive PCC (e.g., PRx_pcc), a first primary antenna SCC) (e.g., PRx_scc), or a second primary antenna SCC (e.g., PRx_scc2). Antenna 1 may be used for receiving the diversity antenna receive PCC (e.g., DRx_pcc), a first diversity antenna SCC (e.g., DRx_scc), or a second diversity antenna SCC (e.g., DRx_scc2). In this case, the modem inputs for adaptive antenna tuning may include the transmit signal level (e.g., of Tx_pcc), the SNR for the receive PCC on Antenna 0 (SNR0_Pcc), the SNR for the first receive SCC on Antenna 0 (SNR0_Scc), the SNR for the second receive SCC on Antenna 0 (SNR0_Scc2), the SNR for the receive PCC on Antenna 1 (SNR1_Pcc), the SNR for the first receive SCC on Antenna 1 (SNR1_Scc), and the SNR for the second receive SCC on Antenna 1 (SNR1_Scc2).

Returning to FIG. 6, PRx_pcc may be driven by a standard offset circle scheme. PRx_scc may be driven by two different schemes. In a first scheme, a UI condition may be assumed as a best guess (e.g., a free space UI condition). This first scheme has a simplicity advantage in that S21 data can be used. A column can be created once upon configuration of CA. The first scheme also captures rolloff of the tuner network, which is a key issue for high frequency bands. In a second scheme, a UI condition may be extrapolated using a UI guess from low band to high band (or vice versa). This second scheme is more complex than the first scheme. DRx_scc and DRx_pcc may use the first scheme since no FBRx information may be available for these.

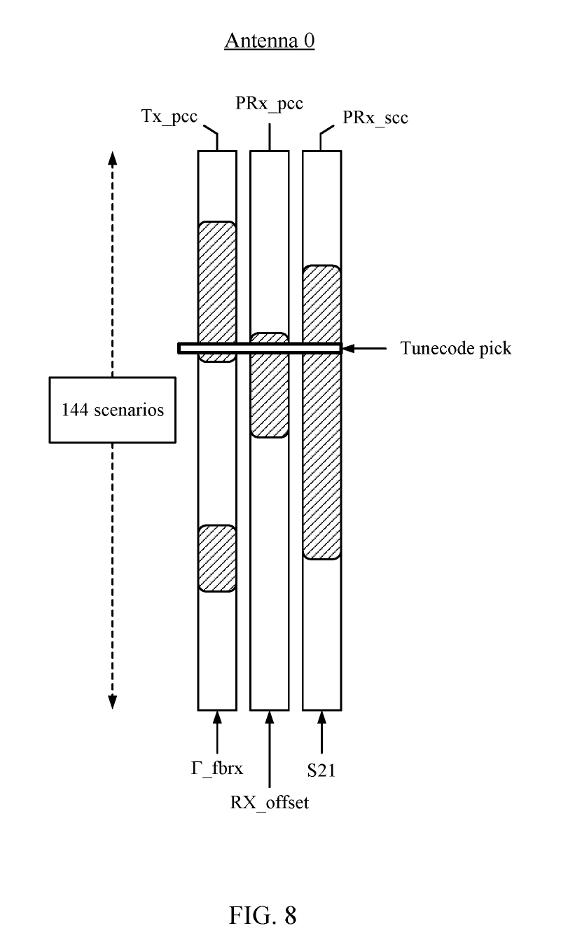

To implement modem adaptive antenna tuning, an ordering system may be defined for each column. Then, a peak value may be defined in each column, as well as items that are in a defined range of the peak value (e.g., all points within x dB from the peak value). FIG. 8 illustrates selecting an example tuner code selection based on one or more rule conditions, in accordance with certain aspects of the present disclosure. A rule system may be defined for determining tuner code selection.

As an example rule system for Antenna 0 of FIG. 6, if Tx >70% max, then go to peak Tx_pcc. In other words, if Tx is weak, focus on protecting Tx. If Tx is ≦70% max, then if Tx<max and SNR0_Pcc <7 dB, go to peak PRx_pcc. Otherwise, pick peak Tx_pcc in set limited by PRx_pcc<5 dB.

As an example rule system for Antenna 1 of FIG. 6, if SNR0_Pcc<3 dB, go to peak Drx_pcc. In this manner, if PCC is weak, the focus is on protecting PCC on all antennas. Otherwise, go to peak Drx_scc. In other words, if PCC is strong, the focus is on getting the best SCC on Antenna 1.

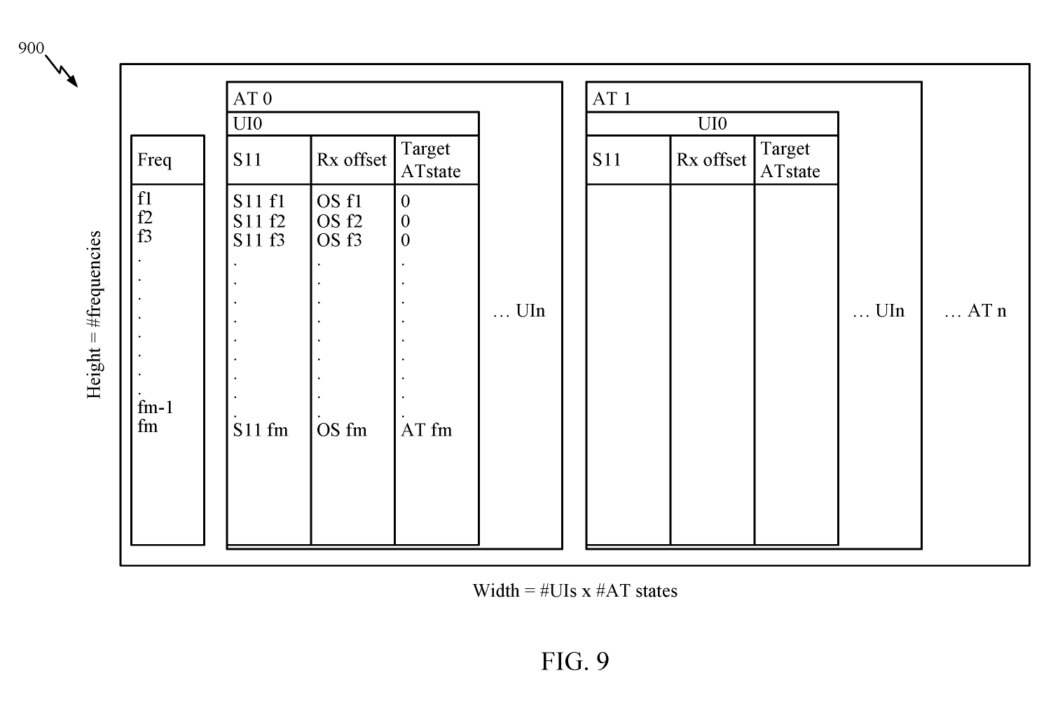

FIG. 9 is an example table 900 of parameters for each of a plurality of frequencies, wherein the parameters are organized according to different antennas and various user interface conditions per antenna, in accordance with certain aspects of the present disclosure. The table 900 may be stored as a look-up table (LUT) in memory, such as nonvolatile (NV) memory, interfaced with a processing system on the user terminal.

For certain aspects, the table 900 may include antenna impedance and Rx offset per UI. For example, the table 900 may include antenna S11 per UI, per antenna (AT) state, to identify the UI condition and target AT state. Each row in the table 900 is a row of data per frequency. There may be a single frequency column (e.g., up to a maximum of 60 frequencies). The frequencies may cover both Tx and Rx, and interpolation may be used between frequencies. Each column in the table 900 is a column of data for each UI and aperture state. For example, each column may include the S11 of the antenna for the UI and AT state, the Rx offset for the UI and AT state, and the target AT state per UI. For example, there may be up to 30 columns of data in the table 900.

The various operations or methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

For example, means for transmitting may comprise a transmitter (e.g., the transceiver front-end 254 of the user terminal 120 depicted in FIG. 2 or the transceiver front-end 222 of the access point 110 shown in FIG. 2) and/or an antenna (e.g., the antennas 252ma through 252mu of the user terminal 120m portrayed in FIG. 2 or the antennas 224a through 224ap of the access point 110 illustrated in FIG. 2). Means for receiving may comprise a receiver (e.g., the transceiver front-end 254 of the user terminal 120 depicted in FIG. 2 or the transceiver front-end 222 of the access point 110 shown in FIG. 2) and/or an antenna (e.g., the antennas 252ma through 252mu of the user terminal 120m portrayed in FIG. 2 or the antennas 224a through 224ap of the access point 110 illustrated in FIG. 2). Means for processing or means for determining may comprise a processing system, which may include one or more processors, such as the RX data processor 270, the TX data processor 288, and/or the controller 280 of the user terminal 120 illustrated in FIG. 2.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a user terminal, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC with the processor, the bus interface, the user interface in the case of an access terminal), supporting circuitry, and at least a portion of the machine-readable media integrated into a single chip, or with one or more FPGAs, PLDs, controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communications, comprising:
determining a first channel characteristic associated with a first component carrier and a first antenna in an apparatus;
determining a second channel characteristic associated with a second component carrier and the first antenna; and
controlling a first tuner coupled to the first antenna based on one or more predetermined characteristics of the first tuner and on at least one of the first channel characteristic or the second channel characteristic, the predetermined characteristics of the first tuner being independent from predetermined characteristics of the first antenna.

2. The method of claim 1, further comprising:
determining a third channel characteristic associated with a third component carrier and a second antenna in the apparatus; and
controlling a second tuner coupled to the second antenna based on the third channel characteristic.

3. The method of claim 2, further comprising:
determining that the third channel characteristic meets a rule condition; and
selecting a tuner code from a predetermined set of tuner codes based on meeting the rule condition, wherein controlling the second tuner comprises applying the selected tuner code to the second tuner to control a variable impedance of the second tuner.

4. The method of claim 2, further comprising:
determining that the third channel characteristic fails to meet a first rule condition;
determining a fourth channel characteristic associated with a fourth component carrier and the second antenna;
determining that the fourth channel characteristic meets a second rule condition; and
selecting a tuner code from a predetermined set of tuner codes based on meeting the second rule condition, wherein controlling the second tuner comprises applying the selected tuner code to the second tuner to control a variable impedance of the second tuner.

5. The method of claim 4, wherein the fourth component carrier is a primary component carrier (PCC) and the third component carrier is a secondary component carrier (SCC).

6. The method of claim 4, wherein the third component carrier is a secondary component carrier (SCC) and the fourth component carrier is another SCC.

7. The method of claim 2, further comprising determining a user interaction condition of the apparatus, wherein:
controlling the first tuner comprises controlling the first tuner based on the user interaction condition of the apparatus and on the at least one of the first channel characteristic or the second channel characteristic; and
controlling the second tuner comprises controlling the second tuner based on the third channel characteristic and the user interaction condition of the apparatus.

8. The method of claim 2, wherein the first antenna is disposed adjacent a first surface of the apparatus and wherein the second antenna is disposed adjacent a second surface of the apparatus, different from the first surface.

9. The method of claim 8, wherein the first surface is a lower surface of the apparatus and wherein the second surface is an upper surface of the apparatus, opposite from the lower surface.

10. The method of claim 8, wherein:
the apparatus comprises a transmit path coupled to the first antenna and the first tuner;
the apparatus comprises a receive path coupled to the second antenna and the second tuner;
the at least one of the first component carrier or the second component carrier comprises a transmit component carrier;
controlling the first tuner comprises controlling the first tuner for the transmit path;
the third component carrier comprises a receive component carrier; and
controlling the second tuner comprises controlling the second tuner for the receive path.

11. The method of claim 1, further comprising determining a user interaction condition of the apparatus, wherein controlling the first tuner comprises controlling the first tuner based on the user interaction condition of the apparatus and on the at least one of the first channel characteristic or the second channel characteristic.

12. The method of claim 11, wherein determining the user interaction condition of the apparatus comprises at least one of:
sensing a proximity parameter for the apparatus;
sensing movement of the apparatus or lack thereof;
detecting whether a device is connected to the apparatus; or
detecting an impedance characteristic of the first antenna.

13. The method of claim 11, wherein determining the user interaction condition of the apparatus comprises assuming a free space condition for the apparatus.

14. The method of claim 11, wherein controlling the first tuner comprises adjusting the first tuner over time as at least one of the user interaction condition of the apparatus, the first channel characteristic, or the second channel characteristic changes.

15. The method of claim 1, wherein controlling the first tuner comprises adjusting the first tuner over time as the at least one of the first channel characteristic or the second channel characteristic changes.

16. The method of claim 1, wherein controlling the first tuner comprises dynamically adjusting the first tuner during operation of the apparatus.

17. The method of claim 1, further comprising:
determining that the first channel characteristic meets a rule condition; and
selecting a tuner code from a predetermined set of tuner codes based on meeting the rule condition, wherein controlling the first tuner comprises applying the selected tuner code to the first tuner to control a variable impedance of the first tuner.

18. The method of claim 1, further comprising:
determining that the first channel characteristic fails to meet a first rule condition;
determining that the second channel characteristic meets a second rule condition; and
selecting a tuner code from a predetermined set of tuner codes based on meeting the second rule condition, wherein controlling the first tuner comprises applying the selected tuner code to the first tuner to control a variable impedance of the first tuner.

19. The method of claim 1, wherein the first component carrier is a transmit primary component carrier (PCC) and wherein the second component carrier is a receive PCC.

20. The method of claim 1, wherein the first component carrier is a transmit primary component carrier (PCC) and the second component carrier is a receive secondary component carrier (SCC).

21. The method of claim 1, wherein the first channel characteristic comprises a signal-to-noise ratio (SNR) of the first component carrier received by the apparatus.

22. The method of claim 1, wherein the first channel characteristic comprises a transmit signal level of the first component carrier.

23. The method of claim 1, wherein controlling the first tuner comprises:
determining power transferred through the first tuner for a set of tuner codes based on the predetermined characteristics of the first tuner; and
selecting a tuner code from the set of tuner codes based on the determined power, wherein controlling the first tuner comprises applying the selected tuner code to the first tuner to control a variable impedance of the first tuner.

24. The method of claim 1, wherein the apparatus comprises a receive path, wherein the first and second component carriers are receive component carriers, and wherein controlling the first tuner comprises controlling the first tuner only for the receive path.

25. The method of claim 24, wherein the first antenna has no transmit path associated therewith.

26. The method of claim 1, wherein controlling the first tuner comprises adjusting the first tuner such that the first antenna is detuned from a second antenna in the apparatus.

27. An apparatus for wireless communications, comprising:
a first antenna;
a first tuner coupled to the first antenna; and
a processor coupled to the first tuner and configured to:
determine a first channel characteristic associated with a first component carrier and the first antenna;
determine a second channel characteristic associated with a second component carrier and the first antenna; and
control the first tuner based on one or more predetermined characteristics of the first tuner and on at least one of the first channel characteristic or the second channel characteristic, the predetermined characteristics of the first tuner being independent from different effective configurations of the first antenna.

28. The apparatus of claim 27, further comprising a second antenna and a second tuner coupled to the second antenna, wherein the processor is further configured to:
determine a third channel characteristic associated with a third component carrier and the second antenna;
determine that the third channel characteristic meets a rule condition;
select a tuner code from a predetermined set of tuner codes based on meeting the rule condition; and
control the second tuner based on the third channel characteristic by applying the selected tuner code to the second tuner to control a variable impedance of the second tuner.

29. The apparatus of claim 27, further comprising a second antenna and a second tuner coupled to the second antenna, wherein the processor is further configured to:
determine a user interaction condition of the apparatus;
determine a third channel characteristic associated with a third component carrier and the second antenna; and
control the second tuner based on the third channel characteristic and the user interaction condition of the apparatus, wherein the processor is configured to control the first tuner by controlling the first tuner based on the user interaction condition of the apparatus and on the at least one of the first channel characteristic or the second channel characteristic.

30. An apparatus for wireless communications, comprising:
means for transceiving a signal;
means for determining a first channel characteristic associated with a first component carrier and the means for transceiving;
means for determining a second channel characteristic associated with a second component carrier and the means for transceiving; and
means for adjusting an impedance for the means for transceiving, based on one or more predetermined characteristics of the means for adjusting and on at least one of the first channel characteristic or the second channel characteristic, the predetermined characteristics of the means for adjusting being independent from predetermined characteristics of the means for transceiving.
